(19) United States
(12) Patent Application Publication
(10) Pub. No.: US 2025/0232621 A1
(43) Pub. Date: Jul. 17, 2025

(54) VEHICLE COMMUNICATION ADAPTER

(71) Applicant: Precision Mounting Technologies, Ltd., Calgary (CA)

(72) Inventors: Reuben C.G. Powell, Calgary (CA); Raymond Cormier, Calgary (CA)

(21) Appl. No.: 19/009,257

(22) Filed: Jan. 3, 2025

Related U.S. Application Data
(60) Provisional application No. 63/620,027, filed on Jan. 11, 2024.

(51) Int. Cl. G07C 5/08; G07C 5/00; H04L 67/12

(52) U.S. Cl. CPC G07C 5/0841; G07C 5/008; H04L 67/12

(57) ABSTRACT

An adapter is connected to a vehicle electrical system of a vehicle, an electronic communication device, and an after-market device mounted to the vehicle. The adapter receives vehicle data from the vehicle electrical system, and transmits the vehicle data to the electronic communication device. In response to determining that the after-market device has been activated by monitoring a connection between the adapter and the after-market device, the adapter is configured to transmit a notification to the electronic communication device. The notification triggers the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

### RELATED APPLICATIONS

This application claims priority to U.S. Provisional Application No. 63/620,027, filed on Jan. 11, 2024, the entire contents of which are hereby incorporated by reference.

### FIELD

The present disclosure relates to adapters and/or docking stations that allow an electronic communication device to communicate with a vehicle and with a device (e.g., an after-market device such as an after-market lighting device) associated with the vehicle.

### BACKGROUND

Emergency lighting devices on emergency vehicles (e.g., police cars, ambulances, firetrucks, etc.) are often after-market lighting devices that are installed after the emergency vehicles are manufactured. Additionally, other after-market devices may be installed on the emergency vehicles and/or other types of vehicles after the vehicles are manufactured. Accordingly, control and monitoring of the after-market devices may not be performed by a vehicle electrical system (e.g., an on-board diagnostic (OBD) system).

### SUMMARY

In one aspect, the disclosure provides an adapter that may include a first connection between the adapter and a vehicle electrical system of a vehicle. The adapter also may include a second connection between the adapter and an electronic communication device. The adapter also may include a third connection between the adapter and an after-market device mounted to the vehicle. The vehicle electrical system may not monitor a status of the after-market device. The adapter also may include an electronic processor coupled to a memory. The electronic processor may be configured to receive vehicle data from the vehicle electrical system via the first connection, and transmit the vehicle data to the electronic communication device via the second connection. The electronic processor also may be configured to determine, by monitoring the third connection between the adapter and the after-market device, that the after-market device has been activated. In response to determining that the after-market device has been activated, the electronic processor also may be configured to transmit a notification to the electronic communication device. The notification may be configured to trigger the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

In another aspect, the disclosure provides a method of controlling an adapter. The method may include receiving, with an electronic processor of the adapter, vehicle data from a vehicle electrical system of a vehicle via a first connection between the adapter and the vehicle electrical system of the vehicle. The method may also include transmitting, with the electronic processor, the vehicle data to an electronic communication device via a second connection between the adapter and the electronic communication device. The method may also include determining, with the electronic processor and by monitoring a third connection between the adapter and an after-market device mounted to the vehicle, that the after-market device has been activated. The vehicle electrical system may not monitor a status of the after-market device. The method may also include in response to determining that the after-market device has been activated, transmitting, with the electronic processor, a notification to the electronic communication device. The notification may be configured to trigger the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

In another aspect, the disclosure provides a docking station for an electronic communication device. The docking station may include a base for supporting the electronic communication device. The docking station may also include a first connection between the docking station and a vehicle electrical system of a vehicle. The docking station may also include a second connection between the docking station and the electronic communication device. The docking station may also include a third connection between the docking station and a lighting device mounted to the vehicle. The vehicle electrical system may not monitor a status of the lighting device. The docking station may also include an electronic processor coupled to a memory. The electronic processor may be configured to receive vehicle data from the vehicle electrical system via the first connection, and transmit the vehicle data to the electronic communication device via the second connection. The electronic processor may also be configured to determine, by monitoring the third connection between the docking station and the lighting device, that the lighting device has been activated. In response to determining that the lighting device has been activated, the electronic processor may be configured to transmit a notification to the electronic communication device. The notification may be configured to trigger the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

Other aspects of the disclosure will become apparent by consideration of the detailed description and accompanying drawings.

### BRIEF DESCRIPTION OF THE DRAWINGS

FIG. 1 illustrates a vehicle with a lighting device mounted on a roof of the vehicle, according to some example embodiments described herein.

FIG. 2 is a perspective view of a 2-in-1 portable electronic device.

FIG. 3 is a side view of the portable electronic device of FIG. 2 in a closed position and with the display portion coupled to the keyboard portion.

FIG. 4 is a perspective view of a docking station configured to support the 2-in-1 portable electronic device of FIGS. 2 and 3, according to some example embodiments described herein.

FIG. 5 illustrates an adapter configured to be used within the vehicle of FIG. 1 in conjunction with the 2-in-1 portable electronic device of FIGS. 2 and 3, according to some example embodiments described herein.

FIG. 6 illustrates a schematic block diagram of a vehicle communication system that includes the vehicle and the lighting device of FIG. 1, the portable electronic device of FIGS. 2 and 3, and the adapter of FIG. 5, according to some example embodiments described herein.

FIG. 7 illustrates a flow chart of a method for controlling the adapter of FIG. 5 to trigger the portable electronic device of FIGS. 2 and 3 to perform certain actions, according to some example embodiments described herein.

FIG. 8 illustrates a flow chart of a method for determining whether the lighting device of FIG. 1 (and/or another after-market device installed in/on the vehicle of FIG. 1) is activated according to some example embodiments described herein.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

As explained previously herein, emergency lighting devices on emergency vehicles (e.g., police cars, ambulances, firetrucks, etc.) are often after-market lighting devices that are installed after the emergency vehicles are manufactured. Accordingly, control and monitoring of the after-market emergency lighting devices may not be performed by a vehicle electrical system (e.g., an on-board diagnostic (OBD) system).

In some instances, it may be advantageous for an electronic communication device associated with (i) the emergency vehicle or (ii) an operator of the emergency vehicle to take one or more actions (e.g., transmitting a notification, initiating logging of vehicle data from the OBD system, etc.) in response to the emergency lighting device being activated. For example, since activation of the emergency lighting device is often indicative that the emergency vehicle is involved in a public safety incident or will soon be involved in a public safety incident (e.g., is traveling on the way to a public safety incident), it may be advantageous to take one or more actions to alert others about the potential public safety incident and/or initiate logging of vehicle data that may later be analyzed with respect to the potential public safety incident. However, the emergency lighting device of an emergency vehicle is often an after-market lighting device that is not controlled or monitored by the vehicle electrical system.

Accordingly, there is a technological problem with emergency vehicles with after-market emergency lighting devices in that such vehicles do not include a unified control and monitoring device that can (i) control and/or monitor vehicle features, (ii) control and/or monitor the after-market lighting device and/or other after-market sensors and/or devices, and (iii) communicate with remote devices. The devices, methods, and systems disclosed herein address this technological problem by providing a universal adapter and/or docking station that allows an electronic communication device to perform all of the above-noted actions (i)-(iii) to improve data logging, providing of notifications, and overall vehicle functionality.

The above-noted technological problem is not limited to emergency vehicles and after-market lighting devices. Rather, the above-noted technological problem may exist with respect to other vehicles and/or other after-market devices installed on such other vehicles and/or installed on emergency vehicles. While this disclosure primarily includes examples involving emergency vehicles and after-market lighting devices, it should be understood that this disclosure is applicable to other vehicles and/or other after-market devices for vehicles (e.g., construction vehicles such as dump trucks, utility vehicles, service vehicles, and any associated after-market devices, and/or the like).

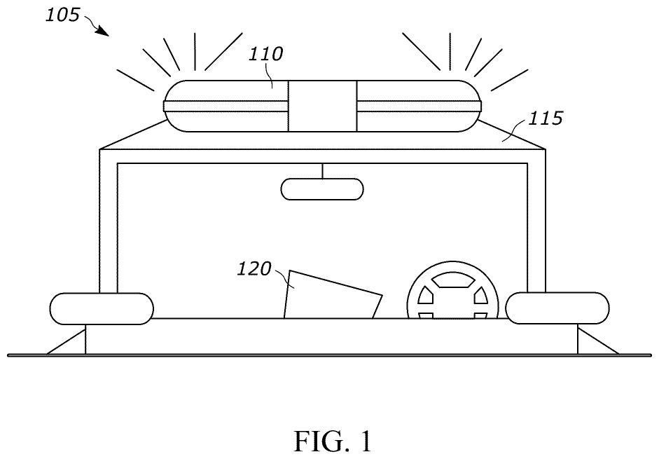

FIG. 1 illustrates a vehicle 105 (e.g., an emergency vehicle) with a lighting device 110 (e.g., an emergency lighting device) mounted on a roof 115 of the vehicle 105. The lighting device 110 may include plurality of light emitting elements (e.g., a plurality of LEDs) configured to illuminate an area outside of the vehicle 105. For example, the lighting device 110 may illuminate in different alternating colors (e.g., white, red, and/or blue) to indicate that an operator of the vehicle 105 is handling a public safety incident/emergency or is traveling on the way to handle a public safety incident/emergency.

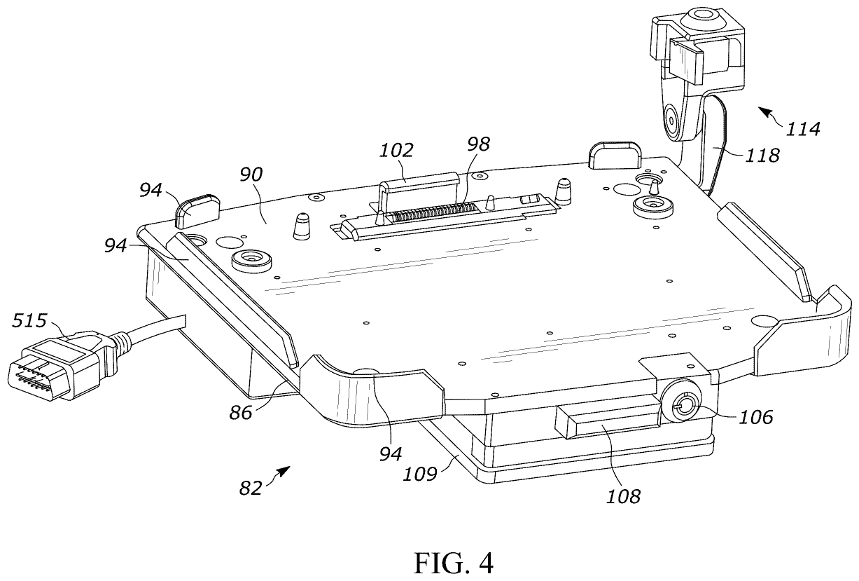

The vehicle 105 may include an electronic communication device 120 that is permanently mounted in the vehicle 105 or removably mounted in the vehicle 105. For example, a permanently mounted electronic communication device 120 may be integrated into a dashboard or other console of the vehicle 105. As another example, a removably mounted electronic communication device 120 (i.e., a portable electronic communication device 120) may be mounted on a docking station 82 (see FIG. 4) that is located within the vehicle 105.

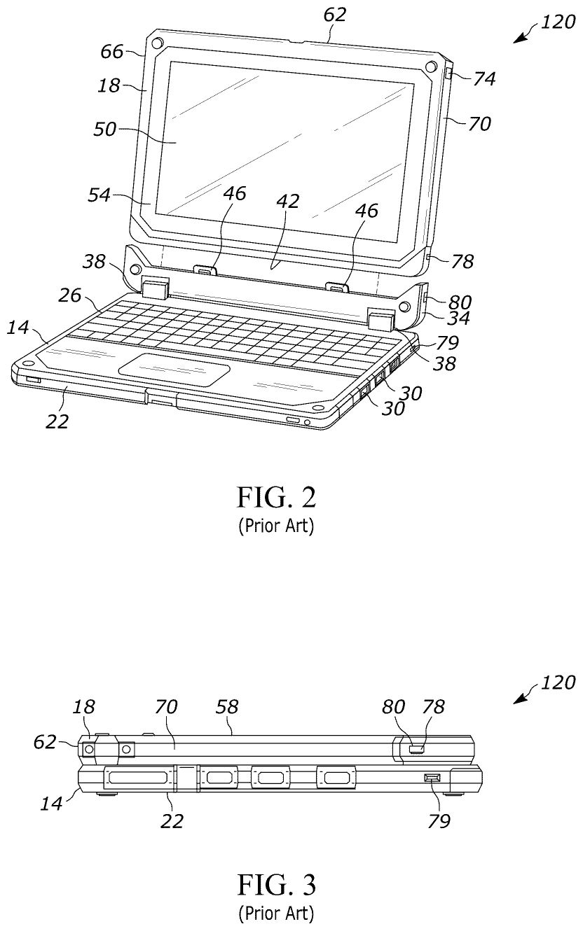

FIGS. 2 and 3 illustrate an example of a portable electronic communication device 120 of the type known as a 2-in-1 electronic device or computer. The illustrated device 120 is a Panasonic Toughbook CF-20, and represents just one example of known 2-in-1 computers.

The electronic communication device 120 includes a keyboard portion 14 and a display portion 18 that can be repeatedly connected together/attached (see FIG. 3), and disconnected/detached (see FIG. 2). The display portion 18 is operable independently from the keyboard portion 14 as a self-contained tablet computer. However, it is often desirable to couple the display portion 18 with the keyboard portion 14 to enable greater functionality than the display portion 18 is capable of on its own.

The keyboard portion 14 includes a body 22 that includes the keyboard 26 as well as various ports and connections 30. The body 22 also houses various internal components of the device 120. The keyboard portion 14 further includes a receiver or cradle 34 that is pivotally coupled (e.g., via hinges 38) to the body 22. The receiver 34 is sized and configured to accept and retain an edge 42 of the display portion 18 for removably coupling the display portion 18 to the keyboard portion 14. A latching arrangement (not shown) is provided to secure the display portion 18 in the receiver 34. One or more release devices (e.g., levers, switches, buttons, etc. —not shown) are provided on one or both of the keyboard portion 14 and the display portion 18, so that when activated, the display portion 18 can be disconnected and removed from within the receiver 34. The receiver 34 includes electrical connectors 46 operable to electrically connect to mating connectors (not shown) in the edge 42 of the display portion 18.

The display portion 18 includes a display screen 50 on a first or front face 54. The display portion further includes a second or rear face 58, and edges 42, 62, 66, and 70. The edges 42, 62, 66, and 70 can include various ports and connections 74. Additionally, the edge 70 includes an aperture or slot 78 sized and configured to receive a lock of the type conventionally available for locking computers. The illustrated slot 78 is known in the art as a Kensington security slot or K-slot, although other types of security apertures or openings are also contemplated by the present disclosure. The slot 78 is a cavity formed within the edge 70 of the display portion 18, with access to the cavity provided by an opening in the housing material that defines the edge 70. The keyboard portion 14 can also include a separate security slot 79. In the illustrated embodiment, the receiver 34 includes an aperture 80 that is in alignment with the slot 78 when the display portion 18 is received in the receiver 34. The aperture 80 permits access to the slot 78 so that the slot can be used when the display portion 18 is mated or docked with the keyboard portion 14. In other embodiments of 2-in-1 computers, the slot 78 may be spaced apart from the receiver 34 such that no aperture 80 is required to access the slot 78 when the display portion 18 is mated or docked with the keyboard portion 14.

The electronic communication device 120 shown in FIGS. 2-3 is merely an example. Other types of electronic communication devices 120 may be used such as tablets, smart phones, laptops, etc.

FIG. 4 illustrates a docking station 82 according to one example embodiment, which is designed to both support and lock the 2-in-1 device 120. More specifically, the docking station 82 is designed to actively and separately lock both the keyboard portion 14 and the display portion 18 when the keyboard portion 14 and the display portion 18 are attached/connected to one another and to the docking station 82. In this manner, the dock 82 prevents unauthorized removal of the display portion 18 from the keyboard portion 14 when the two components are attached together and secured in the docking station 82. It is to be understood that while the docking station 82 of the present disclosure is illustrated as being constructed to mate with the Panasonic Toughbook CF-20, the disclosure can be practiced with any brand, type, or style of 2-in-1 computer products with only minor modifications. Additionally, other docking stations for other types of electronic communication devices 120 (e.g., tablets, smart phones, laptops, etc.) may be used when such other devices are being used as the electronic communication device 120.

Referring to FIG. 4, the docking station 82 includes a base 86 sized and configured for supporting the keyboard portion 14. The base 86 includes an upper base surface 90 on which a bottom surface of the body 22 of the keyboard portion 14 is supported. A plurality of guide projections 94 extend from the surface 90 and are positioned about the periphery of the surface 90 to engage and align the body 22 of the keyboard portion 14 relative to the base 86 of the dock 82. An optional electrical connector 98 extends from the surface 90 and is sized and configured to connect with a mating electrical connector on the bottom surface of the body 22 of the electronic communication device 120. In other embodiments, no electrical connector need be present. A latch 102 also extends from the surface 90 and cooperates with a mating latch-receiving portion (not shown) on the bottom surface of the body 22 to secure the body 22 to the base 86. A lock 106 (e.g., a keyed cylinder lock) is coupled to the base 86 and is operable (by insertion and rotation of a key 107) to prevent movement of the latch 102 when the latch 102 engages and cooperates with the mating latch-receiving portion on the body 22 so that the keyboard portion 14 cannot be removed from the base 86. In the illustrated embodiment, a latch release lever or button 108 extends from a front of the base 86 and can be actuated by a user to release the latch 102. The lock 106 is operable to allow or prevent actuation of the latch release lever or button 108. In other embodiments, any suitable linkage or mechanism can be provided between the lock 106 and the latch 102 to enable the latch 102 to be rendered movable or immovable when the lock is unlocked or locked, respectively. In yet other embodiments, various other arrangements can be used to lock the keyboard portion 14 to the base 86 using a lock on the base 86.

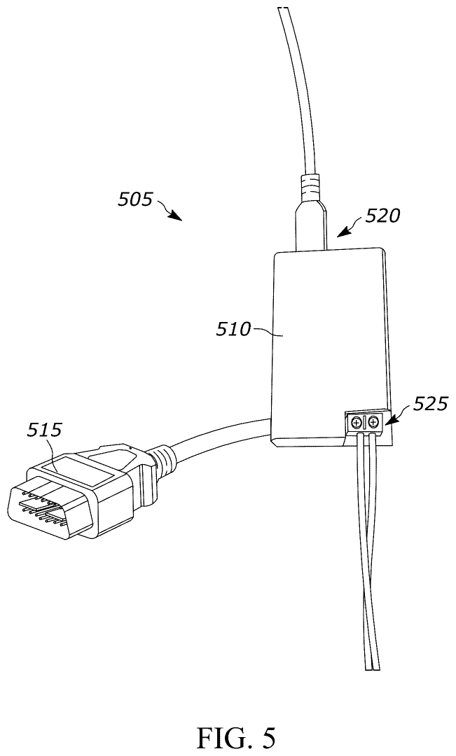

The base 86 can also include electronics and ports/connectors, as is understood in the art. For example, the base 86 may include an on-board diagnostics (OBD) II connector 515 that is configured to connect to an OBD II port of the vehicle 105. Alternatively, the base 86 may be hard-wired to the vehicle electrical system. As another example, the base 86 may include an electrical connection to the lighting device 110 in a similar manner as described below with respect to an adapter 505 of FIG. 5. The base 86 can further include mounting structure 109 designed to mount the base 86 to a support, such as a desk, a wall, a movable cart, a mobile mount support of the type used in vehicles, and the like.

The docking station 82 further includes a display support 114 coupled to the base 86 for providing support and stability to the display portion 18. The display support 114 is particularly useful when the docking station 82 is used in a vehicle so that motion of the vehicle does not unintentionally move the display portion 18 of the device 10. The display support 114 can be sold with the docking station 82, or can be an accessory that is sold separately from the base 86. The display support 114 includes a mounting portion 118 that can be mounted to or coupled with the base 86 using fasteners. Additional details of the docking station 82 are explained in U.S. patent application Ser. No. 15/937,191, now U.S. Pat. No. 10,067,533, which is hereby incorporated by reference in its entirety.

In some instances, the docking station 82 may not include the electrical connector 98, the OBD II connector 515, and/or other electronics and ports/connectors. Rather, the docking station 82 may merely allow the electronic communication device 120 to be physically/mechanically coupled to the docking station 82 in some instances. In such instances, an adapter 505 as shown in FIG. 5 may be used to electrically couple the electronic communication device 120 to the vehicle electrical system and/or to the lighting device 110.

FIG. 5 illustrates the adapter 505 according to one example embodiment. As shown, the adapter 505 may include a housing 510, and an OBD II connector 515 that provides a first connection 515 between the adapter 505 and a vehicle electrical system of the vehicle 105. The adapter 505 may also include a universal serial bus (USB) connector 520 that provides a second connection 520 between the adapter 505 and the electronic communication device 120. The adapter 505 may also include a third connection 525 between the adapter 505 and the lighting device 110.

As shown in FIG. 5, the first connection 515 may be made using a cord that connects the OBD II connector 515 to the housing 510. In other instances, the OBD II connector 515 may be integrated within the housing 510 such that the cord is not present and the adapter housing 510 is plugged directly into the OBD II port of the vehicle 105. In other instances, the first connection 515 may be hard-wired to the vehicle electrical system. As shown in FIG. 5, the second connection 520 may be made using a USB cord that connects a USB port 520 on the housing 510 to a USB port of the electronic communication device 120 (or to a USB port of a docking station 82 to which the electronic communication device 120 is mechanically and electrically attached). In other instances, the USB connector 520 may be integrated within the housing 510 such that the USB cord is not present and the adapter housing 510 is plugged directly into the USB port of the electronic communication device 120 or the docking station 82.

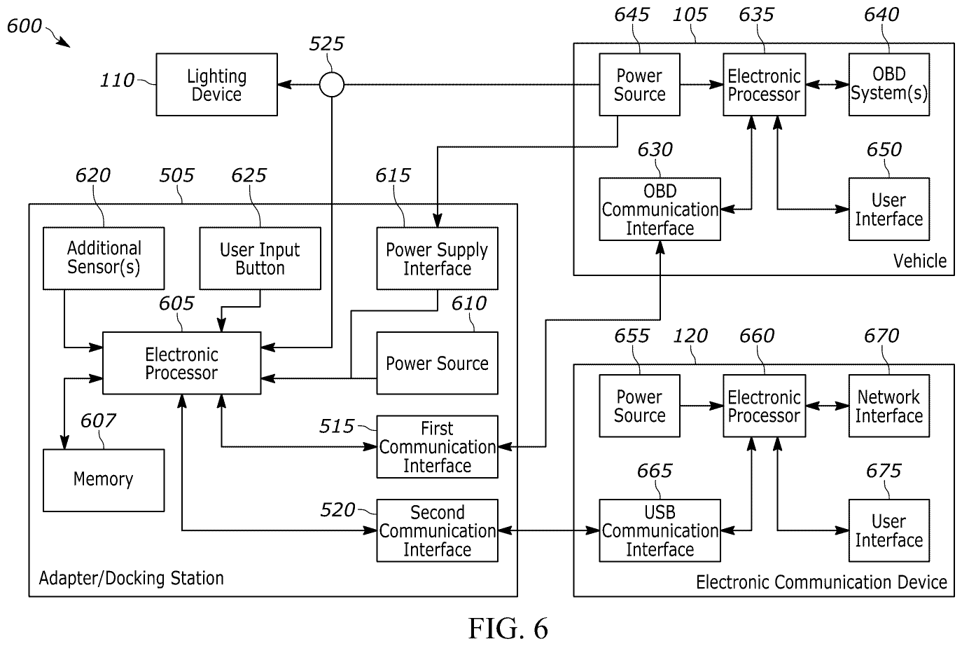

In some instances, the third connection 525 between the adapter 505 and the lighting device 110 is made by splicing into a wire that provides power or an activation signal to the lighting device 110. For example, when the lighting device 110 is installed on the vehicle 105, a lighting user input device (e.g., a user-actuatable switch, button, etc.) may also be installed in a cabin of the vehicle 105 to allow an operator of the vehicle 105 to activate and deactivate the lighting device 110 (i.e., turn the lighting device 110 on and off). Wires may be routed from the lighting user input device to the lighting device 110 to provide power or an activation/deactivation signal to indicate when the lighting device 110 should be activated/deactivated. These wires can be spliced through the adapter 505 to allow the adapter 505 to determine when power and/or an activation signal is being provided to the lighting device 110 as explained in greater detail herein with respect to FIG. 6. In some instances, a wire from the lighting user input device to the lighting device 110 is spliced through the adapter 505 using screw terminals or other known splicing components. In other instances, the wire(s) from the lighting user input device to the lighting device 110 may not be spliced through the adapter 505. Rather, a non-contact sensor (e.g., a non-contact current sensor such as an ammeter clamp) may be used to allow the adapter 505 to determine when power and/or an activation signal is being provided to the lighting device 110. In such instances, the third connection between 525 between the adapter 505 and the lighting device 110 is a wireless/communicative connection that is provided by the non-contact sensor.

FIG. 5 illustrates the adapter 505 as a standalone device that is configured to connect to three different devices associated with the vehicle 105: the vehicle 105 itself (i.e., a vehicle electrical system), the electronic communication device 120, and the lighting device 110 (and/or another after-market device installed in/on the vehicle 105). In other instances, the adapter 505 is integrated with the docking station 82 of FIG. 4. In other words, in some instances, the docking station 82 may include the first connection 515, the second connection 520, and the third connection 525. The details of the adapter 505 disclosed herein also apply to instances in which the adapter 505 is integrated into the docking station 82. For example, details of the housing 510 and connections 515, 520, 525 of the adapter 505 may be applied to the base 86 of the docking station 82. Specifically, while FIG. 4 shows the OBD II connector 515 to connect to the vehicle 105 (i.e., first connection 515) and the electrical connector 98 to connect to the electronic communication device 120 (i.e., second connection 520), the base 86 may also include the third connection 525 between the docking station 82 and the lighting device 110.

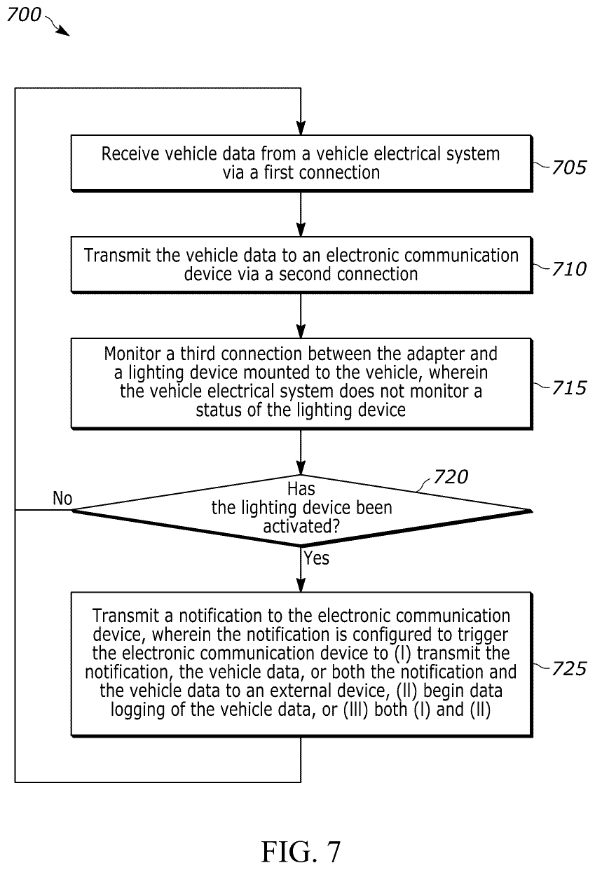

FIG. 6 illustrates a schematic block diagram of a vehicle communication system 600 that includes the vehicle 105, the lighting device 110, and the electronic communication device 120 of FIG. 1 as well as the adapter 505/docking station 82 of FIGS. 5 and 4, respectively, according to one example embodiment. For the sake of readability, FIGS. 6-7 will be explained with respect to the adapter 505. However, it should be understood that the docking station 82 with an integrated adapter 505 may include the same components and may perform the same functionality that is explained herein.

As shown in FIG. 6, the adapter 505 may include a first electronic processor 605 (for example, a microprocessor or other electronic device), a first communication interface 515 (e.g., the OBD II connector 515 to provide the first connection 515 between the adapter 505 and the vehicle 105), a second communication interface 520 (e.g., the USB connector 520 to provide the second connection 520 between the adapter 505 and the electronic communication device 120), and a third connection 525 between the docking station 82 and the lighting device 110. For example, the third connection 525 may include a spliced wire connection, a non-contact sensor configured to sense whether power and/or an activation signal is being applied to the lighting device 110, and/or the like. The adapter 505 also may include a power source 610, a power supply interface 615, an additional sensor(s) 620, and a user input button 625.

The first electronic processor 605 may include input and output interfaces (not shown) and may include and/or be electrically connected to a first memory 607. The first memory includes read only memory (ROM), random access memory (RAM), other non-transitory computer-readable media, or a combination thereof. The first electronic processor 605 is configured to receive instructions and data from the first memory 607 and execute, among other things, the instructions. In particular, the first electronic processor 605 executes instructions stored in the first memory 607 to perform at least some of the methods described herein. The first electronic processor 605 may include any one or a combination of electronic processors located/distributed within the adapter 505. Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations.

The first electronic processor 605 is electrically coupled to a plurality of electrical components of the adapter 505, including the first communication interface 515, the second communication interface 520, the third connection 525, the power source 610, the power supply interface 615, the additional sensor(s) 620, and the user input button 625.

In some instances, the first electronic processor 605 of the adapter 505 is configured to bidirectionally communicate with the vehicle 105 via an OBD communication interface 630 (e.g., a OBD II port located in the vehicle 105). Communications between the adapter 505 and the vehicle 105 include communications between the adapter 505 and a vehicle electrical system that may include a vehicle electronic processor 635, an OBD system(s) 640 that includes OBD sensors and/or additional electronic processors, and combinations thereof. For example, the adapter 505 may connect to a controller area network (CAN) bus of the vehicle 105 via the first communication interface 515 to receive data regarding monitored parameters of the vehicle 105, such as speed, mileage, fuel level, gear selector position, error/trouble codes, open/close status for one or more doors and/or windows of the vehicle 105, airbag status, battery charge level, and/or the like. Additionally, in some instances, the adapter 505 may transmit commands to the vehicle 105 via the first communication interface 515, for example, to roll down one or more windows, to turn on the air conditioning of the vehicle 105, to turn lights (e.g., headlights) on/off, and/or the like. In some instances, the vehicle electronic processor 635 may be similar to and may perform similar general functions as the first electronic processor 605 of the adapter 505. For example, the vehicle electronic processor 635 may include and/or be electrically connected to a memory (not shown) that stores instructions configured to be executed by the vehicle electronic processor 635. In some instances, the first connection 515 between the vehicle 105 and the adapter 505 runs from the OBD communication interface 630 of the vehicle 105 to the first communication interface 515 of the adapter 505 and then to general purpose input/output (GPIO) pins of a system-on-chip (SOC) of the adapter 505 that is acting as the first electronic processor 605.

The vehicle electronic processor 635 may be electrically coupled to a plurality of electrical components of the vehicle 105, including the OBD communication interface 630, the OBD system(s) 640, a power source 645, and a user interface 650. The user interface 650 may provide an indication to an operator of the vehicle 105 relating to a state of the vehicle 105. For example, the user interface 650 includes a suitable display mechanism for displaying a visual output, such as, for example, a liquid crystal display (LCD) touch screen, or an organic light-emitting diode (OLED) touch screen), or other suitable mechanisms. The user interface 650 may also include a speaker or other audio output device configured to provide an audible notification to an operator of the vehicle 105. The power source 645 of the vehicle 105 may include a battery of the vehicle 105. Although not specifically shown in FIG. 6, in some instances, the power source 645 supplies power to other components of the vehicle 105 (e.g., the OBD system(s) 640, the user interface 650, etc.) directly or via the vehicle electronic processor 635. The power source 645 also may provide power to other devices in the vehicle communication system 600 such as the lighting device 110, the adapter 505, and/or the electronic communication device 120. In some instances, the lighting device 110, the adapter 505, and/or the electronic communication device 120 may include their own power sources that may be configured to independently provide power to their respective devices in some situations (see power source 610 of the adapter 505 and power source 655 of the electronic communication device 120). In some instances, these independent power sources in other devices may be charged by the power source 645 of the vehicle 105. In some instances, the adapter 505 may provide both (i) vehicle data from the vehicle electrical system and (ii) power from the power source 645 of the vehicle 105 to the electronic communication device 120 (e.g., for charging purposes and/or for powering the electronic communication device 120).

In some instances, the first electronic processor 605 of the adapter 505 is configured to bidirectionally communicate with a second electronic processor 660 of the electronic communication device 120 via USB communication interface 665 (e.g., a USB port located in the electronic communication device 120). Other types of communication interfaces besides a USB interface are also contemplated (e.g., see electrical connector 98 on the docking station 82 of FIG. 4). In some instances, the second electronic processor 660 may be similar to and may perform similar general functions as the first electronic processor 605 of the adapter 505. For example, the second electronic processor 660 may include and/or be electrically connected to a memory (not shown) that stores instructions configured to be executed by the second electronic processor 660.

The first electronic processor 605 may transmit a notification, vehicle data received from the vehicle 105, and/or both the notification and the vehicle data to the electronic communication device 120 via the second connection 520 as explained in greater detail herein. As one example, the notification may be configured to trigger the electronic communication device 120 to begin logging vehicle data that is being provided by the adapter 505. For example, the electronic communication device 120 may periodically receive vehicle data from the adapter 505 and store the vehicle data in a circular buffer locally on the electronic communication device 120 and/or on a remote storage device (e.g., on a cloud-based computing device) by communicating using a network interface 670 explained below. Upon receiving additional vehicle data, the second electronic processor 660 may overwrite the vehicle data that was previously stored in the circular buffer. However, in response to receiving a notification from the adapter 505 that the vehicle data should be logged, the second electronic processor 660 may store all received vehicle data in a more permanent memory storage location for a predetermined time period or until another notification is received from the adapter 505. In some instances, the memory 607 of the adapter 505 performs similar data storage with respect to vehicle data. In other words, the adapter 505 may locally store vehicle data for later retrieval (i.e., function as a “black box”).

As another example, the notification from the adapter 505 may be configured to trigger the electronic communication device 120 to transmit the notification, the vehicle data, or both the notification and the vehicle data to an external device. As shown in FIG. 6, the electronic communication device 120 may include a network interface 670. The network interface 670 may be coupled to the second electronic processor 660 and may be configured to send and receive information to and from external devices such as remotely located devices including communication devices at a remotely located dispatch center, cloud-based communication devices/servers, and/or the like. For example, the network interface 670 includes a wireless Radio Frequency (RF) communication transceiver and an antenna, for example a RF antenna, for wirelessly communicating with other devices over one or more communication networks (e.g., a long-distance cellular communication network). Alternatively or in addition, the network interface 670 may include a connector or port for receiving a wired connection to one or more communication networks, such as an Ethernet cable. The second electronic processor 660 may wirelessly communicate information (e.g., notifications and/or vehicle data received from the adapter 505, etc.) through the network interface 670 to remote external devices. Similarly, the second electronic processor 660 may output data received via the network interface 670 (for example, information received from a communication device at a dispatch center and/or the like) using user interface 675. In some embodiments, the user interface 675 of the electronic communication device 120 may include one or more output devices that provide outputs to a user (e.g., a display (which may include a touchscreen), a speaker, etc.) and one or more input devices that receive inputs from the user (e.g., a microphone, the display embodied as a touchscreen, etc.).

In some instances, the first electronic processor 605 of the adapter 505 is configured to detect an activation of the lighting device 110 (and/or another after-market device installed in/on the vehicle 105). In some instances, the lighting device 110 may be powered by the power source 645 of the vehicle 105. However, in such situations, the lighting device 110 may not otherwise be coupled to the vehicle electronic processor 635 or the OBD system(s) 640. Thus, the vehicle electronic processor 635 or the OBD system(s) 640 (i.e., the vehicle electrical system) may not be able to monitor a status of the lighting device 110 (i.e., to determine whether the lighting device 110 has been activated). To allow for such a determination, the adapter 505 may include the third connection 525 that monitors a power wire between the power source 645 and the lighting device 110 (or in an activation signal wire between the lighting device 110 and a lighting user input device). The third connection 525 may run through an analog input through the GPIO pins of the SOC that is acting as the first electronic processor 605, which allows the first electronic processor 605 to detect whether current is being provided from the power source 645 to the lighting device 110 (i.e., to detect whether the lighting device 110 is activated). In response to detecting that the lighting device 110 (and/or another after-market device installed in/on the vehicle 105) is activated, the first electronic processor 605 may take one or more actions as explained in greater detail below with respect to FIG. 7.

The power supply interface 615 of the adapter 505 may include conditioning circuitry that may include combinations of active and passive components to regulate or control the power received from the power source 645 of the vehicle prior to power being provided to one or more elements of the adapter 505. The power supply interface 615 may include charging circuitry configured to charge the power source 610 of the adapter 505 using the power source 645 of the vehicle 105.

In some embodiments, the devices 105, 110, 120, and 505 shown in the vehicle communication system 600 of FIG. 6 may include fewer or additional components in configurations different from that illustrated in FIG. 6. For example, in some embodiments, the adapter 505 does not include the power source 610 and instead is solely powered by the power source 645 of the vehicle 105. As another example, although not shown in FIG. 6, the electronic communication device 120 may include a power supply interface similar to the power supply interface 615 of the adapter 505 in order to receive power from the power source 645 of the vehicle 105. In this example, the power source 655 of the electronic communication device 120 may be charged by the power source 645 of the vehicle 105. As yet another example, although a power connection between the adapter 505 and the vehicle 105, and a communicative connection between the first communication interface 515 and the OBD communication interface 630 are shown separately, in some instances, both connections are included in the same wiring harness (e.g., an OBD II wiring harness configured to connect to the OBD II port of the vehicle 105). As yet another example, the lighting device 110 may include its own power source instead of being powered by the power source 645 of the vehicle 105. In this example, the third connection 525 may monitor (e.g., by splicing into, by monitoring using a non-contact sensor, etc.) a power wire between the lighting device power source and the lighting device 110 or an activation signal wire between the lighting device and a lighting user input device in a similar manner as described above with respect to FIG. 6. As yet another example, the additional sensor(s) 620 and/or the user input button 625 may not be included in the adapter 505 in some instances.

While the communicative connections 515, 520, and 525 between devices 505, 105, 110, and 120 in the vehicle communication system 600 of FIG. 6 have primarily been described as being wired connections, in some instances, any one or a combination of these connections 515, 520, and 525 are implemented at least partially in a wireless manner. In some instances, short-range wireless communication (e.g., a Bluetooth™ communication) may be used to communicate between devices 505, 105, and/or 120. For example, the network interface 670 of the electronic communication device 120 may include short-range wireless communication transceivers that may be configured to communicate with a corresponding wireless transceiver in the adapter 505, the vehicle 105, the lighting device 110, and/or a current sensor associated with a power line of the lighting device 110.

FIG. 7 illustrates a flow chart of a method 700 for controlling the adapter 505 to trigger the electronic communication device 120 to perform certain actions, according to one example embodiment. While a particular order of processing steps, data receptions, and/or data transmissions is indicated in FIG. 7 as an example, timing and ordering of such steps, receptions, and transmissions may vary where appropriate without negating the purpose and advantages of the examples set forth in detail throughout the remainder of this disclosure. In some embodiments, the method 700 is performed by the first electronic processor 605 of the adapter 505, which may include any one or a combination of electronic processors located/distributed within the adapter 505 as explained previously herein.

An instance of the method 700 begins at block 705, where the first electronic processor 605 of the adapter 505 receives vehicle data from the vehicle electrical system of the vehicle 105 via the first connection 515. For example, the adapter 505 may periodically receive the vehicle data from the vehicle electrical system in the course of normal operation to monitor vehicle functionality. In some instances, such normal monitoring of vehicle data may include the adapter 505 receiving a subset of all vehicle data that is being monitored by the vehicle electrical system. However, the adapter 505 may be configured to request additional vehicle data (e.g., a larger subset of vehicle, all vehicle data, etc.) at certain times as explained herein. In some instances, normal monitoring of vehicle data may include the adapter 505 receiving all vehicle data that is being monitored by the vehicle electrical system. In such instances, the first electronic processor 605 of the adapter 505 may be configured to determine how much of the vehicle data to relay to the electronic communication device 120 as explained herein.

At block 710, the first electronic processor 605 transmits the vehicle data to the electronic communication device 120 via the second connection 520. In some situations, the first electronic processor 605 transmits only a subset of the vehicle data to the electronic communication device 120. In other situations, the first electronic processor 605 may transmit a larger subset of or all of the vehicle data to the electronic communication device 120. As explained previously herein, the electronic communication device 120 may temporarily store the vehicle data (and/or transmit the vehicle data to be temporarily stored by a remote device) during normal monitoring of the vehicle 105. In some instances, the memory 607 of the adapter 505 performs similar data storage with respect to vehicle data as the electronic communication device 120 (e.g., to function as a “black box”).

At block 715, the first electronic processor 605 monitors the third connection 525 between the adapter 505 and the lighting device 110 (and/or another after-market device installed in/on the vehicle 105) mounted to the vehicle 105. As previously explained, in many instances, the vehicle electrical system does not monitor a status of the lighting device 110 (and/or another after-market device installed in/on the vehicle 105) since the lighting device 110 is often installed as an after-market lighting device 110 after manufacturing of the vehicle 105. Also as previously explained, the first electronic processor 605 may monitor a current through analog GPIO pins from the third connection 525 (e.g., a spliced wire connection, a non-contact sensor configured to sense whether power and/or an activation signal is being applied to the lighting device 110, and/or the like) associated with a power wire to the lighting device 110 in order to determine whether current is being supplied to the lighting device 110.

At block 720, the first electronic processor 605 determines whether the lighting device 110 (and/or another after-market device installed in/on the vehicle 105) has been activated by monitoring the third connection 525 between the adapter 505 and the lighting device 110 (e.g., to detect whether current is being supplied to the lighting device 110). In response to determining that the lighting device 110 is not activated (e.g., detecting the absence of current), the method 700 proceeds back to block 705 to repeat blocks 705 through 715. On the other hand, in response to determining that the lighting device 110 is activated (e.g., detecting the presence of current), the method 700 proceeds to block 725.

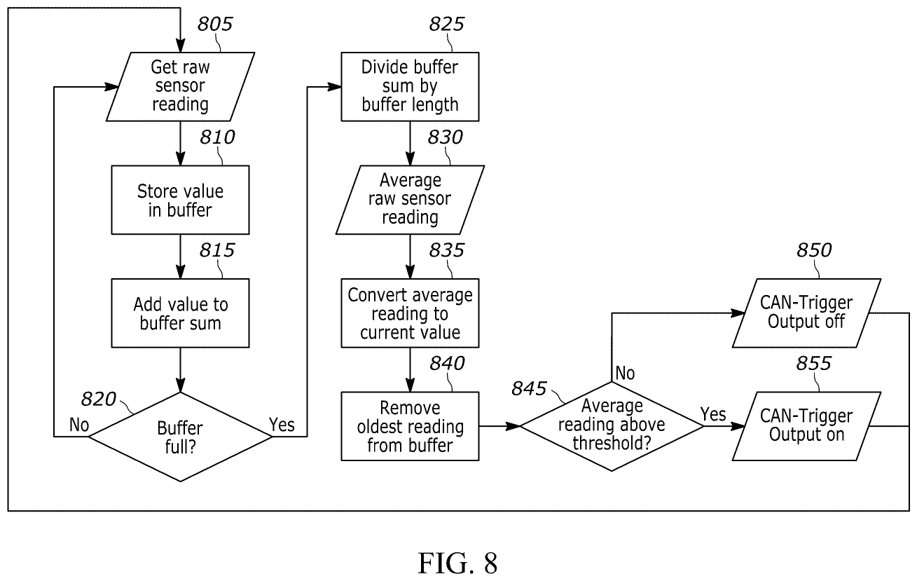

FIG. 8 illustrates a flow chart of a method 800 for determining whether the lighting device 110 (and/or another after-market device installed in/on the vehicle 105) is activated according to one example. The first electronic processor 605 may perform the method 800 as a sub-method of the method 700 at block 720 of the method 700. While a particular order of processing steps, data receptions, and/or data transmissions is indicated in FIG. 8 as an example, timing and ordering of such steps, receptions, and transmissions may vary where appropriate without negating the purpose and advantages of the examples set forth in detail throughout the remainder of this disclosure. In some embodiments, the method 800 is performed by the first electronic processor 605 of the adapter 505, which may include any one or a combination of electronic processors located/distributed within the adapter 505 as explained previously herein.

At block 805, the first electronic processor 605 receives a raw sensor reading (e.g., through analog GPIO pins from the third connection 525). The raw sensor reading may be indicative of a current being supplied to the lighting device 110 (and/or another after-market device installed in/on the vehicle 105) as described previously herein.

At block 810, the first electronic processor 605 stores the raw sensor reading in a buffer (e.g., a circular buffer). At block 815, the first electronic processor 605 adds the raw sensor reading to a buffer sum of the values stored in the buffer. At block 820, the first electronic processor 605 determined whether the buffer is full. When the buffer is not full, the method 800 proceeds back to block 805 to continue receiving raw sensor readings and performing blocks 810 and 815. On the other hand, when the buffer is full, the method proceeds to block 825.

At block 825, the first electronic processor 605 divides the buffer sum by a length of the buffer (i.e., buffer length) to determine an average raw sensor value at block 830. At block 835, the first electronic processor 605 converts the average raw sensor value to an average current value (e.g., in Amps). At block 840, the first electronic processor 605 removes an oldest raw sensor reading from the buffer to make room for a new raw sensor reading.

At block 845, the first electronic processor 605 determines whether the average current value that was determined from an average raw sensor value is above a predetermined threshold. For example, the predetermined threshold may be configured to be an amount that indicates when current is flowing in the wires that provide power to the lighting device 110 (and/or another after-market device installed in/on the vehicle 105). When the average current value is below the predetermined threshold, the first electronic processor 605 may determine that the lighting device 110 (and/or another after-market device installed in/on the vehicle 105) is not on/enabled (i.e., not receiving power). Accordingly, the method 800 proceeds to block 850 where a triggering/notification for the electronic communication device 120 is turned off/disabled by the first electronic processor 605. On the other hand, when the average current value is at or above the predetermined threshold, the first electronic processor 605 may determine that the lighting device 110 (and/or another after-market device installed in/on the vehicle 105) is on/enabled (i.e., receiving power). Accordingly, the method 800 proceeds to block 855 where a triggering/notification for the electronic communication device 120 is turned on/enabled by the first electronic processor 605. In some instances, block 855 is identical to or similar to block 725 of FIG. 7 that is explained below. The explanation of block 725 included herein applies to block 855 in such instances. As shown in FIG. 8, after execution of either of blocks 850 and 855, the method 800 proceeds back to block 805 to repeat to continue to monitor the third connection 525.

Referring back to FIG. 7, at block 725, in response to determining that the lighting device 110 (and/or another after-market device installed in/on the vehicle 105) has been activated, the first electronic processor 605 transmits a notification to the electronic communication device 120. In some instances, the notification is configured to trigger the electronic communication device 120 to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data. In some instances, the lighting device 110 being activated is indicative that an operator of the vehicle 105 is handling a public safety incident/emergency or is traveling on the way to handle a public safety incident/emergency. Activation of another after-market device installed in/on the vehicle 105 may additionally or alternatively indicate that the vehicle 105 is about to engage in activity that is worth monitoring since the activity involves use of the another after-market device installed in/on the vehicle 105 (e.g., use of an attachment on a dump truck to load or unload materials). Accordingly, providing a notification that the lighting device 110 (and/or another after-market device installed in/on the vehicle 105) has been activated may be useful for a number of different example reasons as explained below.

After the notification is received by the electronic communication device 120 from the adapter 505, the notification and/or the vehicle data may be provided by the electronic communication device 120 to a dispatch center and/or to a cloud computing device to provide a central notification to a public safety agency and to allow for remote monitoring of the vehicle data. For example, a dispatch center may open a new incident record and begin closely monitoring vehicle data in response to receiving the notification. The notification also may be used, for example, by a cloud computing device, to trigger a traffic signal interruption and/or to provide related notifications to communication devices of drivers of nearby vehicles.

In some instances, in response to determining that the lighting device 110 has been activated, the first electronic processor 605 may request a larger subset of or all of the vehicle data from the vehicle electrical system and/or may transmit a larger subset of or all of the vehicle data to the electronic communication device 120 compared to the smaller subset of vehicle data that may be transmitted to the electronic communication device 120 when the lighting device 110 is not activated (i.e., during normal monitoring).

In some instances, the notification being received by the electronic communication device 120 triggers the electronic communication device 120 to begin data logging (e.g., permanent data logging) of the vehicle data. For example, the electronic communication device 120 may permanently store the vehicle data received while the lighting device 110 is activated since such vehicle data may be related to a public safety incident. Thus, while some vehicle data received during normal monitoring when the lighting device 110 is not activated may be overwritten or discarded after a certain period of time, the vehicle data received while the lighting device 110 is activated may be permanently stored locally on the electronic communication device 120 and/or on a remote device. In some instances, any vehicle data whether temporarily stored or permanently stored may be stored with a time stamp of when such data was gathered from the vehicle electrical system, the adapter 505, and/or the electronic communication device 120. In some instances, the first electronic processor 605 also time stamps a detection of activation of the lighting device 110 for storage along with the vehicle data. In some instances, the memory 607 of the adapter 505 performs similar data storage with respect to vehicle data as that described immediately above with respect to the electronic communication device 120 (e.g., to function as a “black box”).

The vehicle data may be permanently stored for a predetermined time period and/or until the first electronic processor 605 determines that the lighting device 110 has been deactivated or has been deactivated for a predetermined time period. As shown in FIG. 7, the method 700 may repeat after block 725 to allow the adapter 505 to continue to receive vehicle data and provide the vehicle data to the electronic communication device 120.

As an alternative manner to transmit the notification from the adapter 505 to the electronic communication device 120, the adapter 505 may include the user input button 625 shown in FIG. 6. The user input button 625 may be located on the housing 510 of the adapter 505, on the docking station 82, or may be located elsewhere in the vehicle 105 (e.g., in a discrete location) but still communicatively coupled to the first electronic processor 605. In some instances, the vehicle electrical system does not monitor a status of the user input button 625, for example, because the user input button 625 is an after-market accessory associated with the adapter 505. In some instances, the first electronic processor 605 is configured to determine that the user input button 625 has been actuated in response to a user input, and in response to determining that the user input button 625 has been actuated, transmit the notification to the electronic communication device 120. The notification transmitted in this situation may be the same as or similar to the notification transmitted to the electronic communication device 120 at block 725 of FIG. 7. In some instances, the user input button 625 may be referred to as a panic button or a SOS button. In some instances, the electronic communication device 120 may be configured to perform additional functions in response to receiving the notification, for example, when the notification is received in response to actuation of the user input button 625. For example, in response to the user input button 625 being actuated, the first electronic processor 605 may transmit the notification to the electronic communication device 120 along with an indication that the user input button 625 has been actuated. In response thereto, the electronic communication device 120 may dispatch additional units/personnel/equipment to a location of the vehicle, may dispatch particular public safety personnel (e.g., emergency medical response personnel), and/or the like. The function(s) of the user input button 625 may be user-configurable as desired.

As shown in FIG. 6, in some instances, the adapter 505 includes an additional sensor(s) 620 such as a temperature sensor, an accelerometer, a sonar sensor, a gun lock release sensor, force/vibration sensors that indicate forces/vibrations experienced by an operator, and/or the like. The additional sensor(s) 620 may be located on the housing 510 of the adapter 505, on the docking station 82, and/or may be located elsewhere in the vehicle 105 but still communicatively coupled to the first electronic processor 605. In some instances, the vehicle electrical system does not monitor sensor data sensed by the additional sensor(s) 620, for example, because the additional sensor(s) 620 is an after-market accessory. In some instances, the additional sensor(s) include controllers and/or sensors associated with after-market devices such as the lighting device 110 (e.g., a lighting device controller and/or sensor, a siren controller and/or sensor, and/or the like). In some instances, the first electronic processor 605 is configured to receive the sensor data from the additional sensor(s) 620, and transmit the sensor data to the electronic communication device 120 via the second connection 520. The sensor data from the additional sensor(s) 620 may be time stamped and stored with the vehicle data in some instances. In other words, data logged by the electronic communication device 120 and/or the adapter 505 may include various data from various sources such as the vehicle electrical system, after-market sensors, and/or after-market devices and their associated sensors. In some instances, the additional sensor(s) 620 may be said to provide additional third connections 525 to after-market devices/accessories. For example, some of the additional sensor(s) may be similar to the third connections 525 and may be configured to detect whether another after-market device (e.g., a siren, another type of lighting device, and/or the like) is enabled/activated. As similar example, the after-market device may be a gun clamp/gun lock release, and the additional third connection 525 may include a sensor configured to determine when a gun has been removed from the gun clamp/gun lock.

Monitoring of the above-noted additional third connection(s) 525 may additionally or alternatively trigger the notification that is transmitted from the adapter 505 to the electronic communication device 120 at block 725 of FIG. 7. In some instances, the first electronic processor 605 may monitor multiple third connections 525 to determine whether any one or a combination of after-market devices have been activated. In response to determining that any one or a combination of the after-market devices have been activated, the first electronic processor 605 may transmit the notification from the adapter 505 to the electronic communication device 120 at block 725 of FIG. 7. For example, the first electronic processor 605 may be configured to send the notification (at block 725) in response to determining that both the lighting device 110 (connected via the third connection 525) and a siren (connected via an additional third connection 525) have been activated/enabled. As another example, the first electronic processor 605 may be configured to send the notification (at block 725) in response to determining that either one or both of the lighting device 110 (connected via the third connection 525) and the siren (connected via the additional third connection 525) have been activated/enabled. The adapter 505 may be configured to operate in either of the above-noted manners or in additional manners as desired by a user.

In some instances, in response to the adapter 505 determining that the lighting device 110 has been activated (and/or in response to the user input button 625 being actuated), the adapter 505 may enable one or more additional sensor(s) 620. For example, the additional sensor(s) 620 may include one or more on-board video cameras that provide image/video data to the electronic communication device 120 directly or via the adapter 505. Enabling the on-board video cameras in such a manner may increase the likelihood of useful data being captured (e.g., data relating to a public safety incident/emergency) while allowing the cameras to remain off to reduce power consumption and network bandwidth and storage that may otherwise be used to transmit less useful images/video when lighting device 110 is deactivated and when the user input button 625 not been actuated.

As indicated in FIGS. 6-7, in some instances, the adapter 505 leverages a network connection of the electronic communication device 120 to communicate with remotely located external devices to provide notifications, vehicle data (e.g., for fleet management), etc. For example, the adapter 505 may not include its own network interface/connection to communicate directly over a communication network (e.g., a cellular network) with an external device that is located remotely from the vehicle 105. Rather, the first electronic processor 605 of the adapter 505 may be configured to transmit the notification regarding activation of the lighting device 110, the vehicle data, or both the notification and the vehicle data to the external device via a network interface/connection of the electronic communication device 120.

Similarly, commands from a remote device (e.g., at a dispatch center) may be provided to the adapter 505 via the electronic communication device 120. The electronic communication device 120 may additionally or alternatively provide commands to the adapter 505 that are relayed by the adapter 505 to the vehicle electrical system. In other words, the first electronic processor 605 may be configured to receive a command from the electronic communication device 120 via the second connection 520, and transmit the command to the vehicle electrical system via the first connection 515 to cause the vehicle electrical system to control a component of the vehicle 105 in accordance with the command. For example, a communication device at a dispatch center may remotely activate certain lights on the vehicle 105 (e.g., headlights, cabin lights, etc.) by communicating with the adapter 505 via the electronic communication device 120. In a similar manner, the first electronic processor 605 may determine that a cabin temperature of the vehicle 105 has exceeded a predetermined threshold when the vehicle 105 is parked (e.g., by monitoring an additional temperature sensor 620). In response thereto, the first electronic processor 605 may send a command to the vehicle electrical system to roll down one or more windows and/or activate the air conditioning, for example, for vehicles 105 that are known to be assigned to canine/dog (K-9) units.

In some instances, the first electronic processor 605 may control other devices to provide outputs in various situations. For example, the adapter 505 may include or be coupled to after-market status lights (e.g., light-emitting diodes) that are controlled to indicate a status of the adapter 505 (e.g., whether the adapter 505 has transmitted the notification to the electronic communication device 120 (at block 725 of FIG. 7) and whether vehicle data is currently being logged by the adapter 505 and/or the electronic communication device 120). As another example, in some instances, the third connection(s) 525 allows the first electronic processor 605 to enable/activate an after-market device (e.g., the lighting device 110) by providing power to the after-market device or allowing power to be provided to the after-market device. Continuing this example, the first electronic processor 605 may determine that first after-market device (e.g., a siren) has been activated by monitoring a respective third connection 525 associated with the first after-market device. In response thereto, the first electronic processor 605 may activate a second after-market device (e.g., the lighting device 110) based on pre-configured settings that indicate that the first and second after market devices should be activated together. Further continuing this example, the first electronic processor 605 may additionally or alternatively be able to function in the opposite manner where the first electronic processor 605 may activate the first after-market device in response to determining that the second after-market device has been activated. The adapter 505 may be configurable by a user as desired to take different actions (e.g., provide different outputs to one or more other devices) in response to one or more detected inputs/monitored data.

Various features and advantages of the disclosure are set forth in the following claims.

What is claimed is:

1. An adapter comprising:
a first connection between the adapter and a vehicle electrical system of a vehicle;
a second connection between the adapter and an electronic communication device;
a third connection between the adapter and an after-market device mounted to the vehicle, wherein the vehicle electrical system does not monitor a status of the after-market device; and
an electronic processor coupled to a memory, the electronic processor configured to:
receive vehicle data from the vehicle electrical system via the first connection,
transmit the vehicle data to the electronic communication device via the second connection,
determine, by monitoring the third connection between the adapter and the after-market device, that the after-market device has been activated, and
in response to determining that the after-market device has been activated, transmit a notification to the electronic communication device, wherein the notification is configured to trigger the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

2. The adapter of claim 1, further comprising a user input button, wherein the vehicle electrical system does not monitor a status of the user input button;
wherein the electronic processor is configured to:
determine that the user input button has been actuated in response to a user input, and
in response to determining that the user input button has been actuated, transmit the notification to the electronic communication device.

3. The adapter of claim 1, further comprising a sensor, wherein the vehicle electrical system does not monitor sensor data sensed by the sensor;
wherein the electronic processor is configured to:
receive the sensor data from the sensor, and
transmit the sensor data to the electronic communication device via the second connection.

4. The adapter of claim 1, wherein the first connection includes an on-board diagnostics (OBD) II connector configured to connect to an OBD II port of the vehicle, and wherein the second connection includes a universal serial bus (USB) connector configured to connect to a USB port of the electronic communication device.

5. The adapter of claim 1, wherein the electronic processor is configured to:
receive a command from the electronic communication device via the second connection; and
transmit the command to the vehicle electrical system via the first connection to cause the vehicle electrical system to control a component of the vehicle in accordance with the command.

6. The adapter of claim 1, wherein the external device is remotely located from the vehicle;
wherein the electronic processor is configured to transmit the notification, the vehicle data, or both the notification and the vehicle data to the external device via a network connection of the electronic communication device; and
wherein the adapter does not include its own network connection to communicate directly with the external device.

7. The adapter of claim 1, further comprising an additional third connection between the adapter and a second after-market device mounted to the vehicle, wherein the vehicle electrical system does not monitor a status of the second after-market device;
wherein the electronic processor is configured to:
determine, by monitoring the additional third connection between the adapter and the second after-market device, that the second after-market device has been activated, and
in response to determining that the second after-market device has been activated, transmit the notification to the electronic communication device.

8. The adapter of claim 7, wherein the electronic processor is configured to:
activate the after-market device in response to determining that the second after-market device has been activated; and
activate the second after-market device in response to determining that the after-market device has been activated.

9. The adapter of claim 1, wherein the after-market device includes a lighting device.

10. A method of controlling an adapter, the method comprising:
receiving, with an electronic processor of the adapter, vehicle data from a vehicle electrical system of a vehicle via a first connection between the adapter and the vehicle electrical system of the vehicle;
transmitting, with the electronic processor, the vehicle data to an electronic communication device via a second connection between the adapter and the electronic communication device;
determining, with the electronic processor and by monitoring a third connection between the adapter and an after-market device mounted to the vehicle, that the after-market device has been activated, wherein the vehicle electrical system does not monitor a status of the after-market device; and
in response to determining that the after-market device has been activated, transmitting, with the electronic processor, a notification to the electronic communication device, wherein the notification is configured to trigger the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

11. The method of claim 10, further comprising:
determining, with the electronic processor, that a user input button has been actuated in response to a user input, wherein the vehicle electrical system does not monitor a status of the user input button; and
in response to determining that the user input button has been actuated, transmitting, with the electronic processor, the notification to the electronic communication device.

12. The method of claim 10, further comprising:
receiving, with the electronic processor, sensor data from a sensor, wherein the vehicle electrical system does not monitor sensor data sensed by the sensor; and
transmitting, with the electronic processor, the sensor data to the electronic communication device via the second connection.

13. The method of claim 10, further comprising:
receiving, with the electronic processor, a command from the electronic communication device via the second connection; and
transmitting, with the electronic processor, the command to the vehicle electrical system via the first connection to cause the vehicle electrical system to control a component of the vehicle in accordance with the command.

14. The method of claim 10, wherein the external device is remotely located from the vehicle, and wherein the adapter does not include its own network connection to communicate directly with the external device; and
wherein transmitting the notification, the vehicle data, or both the notification and the vehicle data to the external device includes transmitting the notification, the vehicle data, or both the notification and the vehicle data to the external device via a network connection of the electronic communication device.

15. A docking station for an electronic communication device, the docking station comprising:
a base for supporting the electronic communication device;
a first connection between the docking station and a vehicle electrical system of a vehicle;
a second connection between the docking station and the electronic communication device;
a third connection between the docking station and a lighting device mounted to the vehicle, wherein the vehicle electrical system does not monitor a status of the lighting device; and
an electronic processor coupled to a memory, the electronic processor configured to:
receive vehicle data from the vehicle electrical system via the first connection,
transmit the vehicle data to the electronic communication device via the second connection,
determine, by monitoring the third connection between the docking station and the lighting device, that the lighting device has been activated, and
in response to determining that the lighting device has been activated, transmit a notification to the electronic communication device, wherein the notification is configured to trigger the electronic communication device to (i) transmit the notification, the vehicle data, or both the notification and the vehicle data to an external device, (ii) begin data logging of the vehicle data, or (iii) both (i) transmit the notification, the vehicle data, or both the notification and the vehicle data to the external device and (ii) begin data logging of the vehicle data.

16. The docking station of claim 15, further comprising a user input button, wherein the vehicle electrical system does not monitor a status of the user input button;
wherein the electronic processor is configured to:
determine that the user input button has been actuated in response to a user input, and
in response to determining that the user input button has been actuated, transmit the notification to the electronic communication device.

17. The docking station of claim 15, further comprising a sensor, wherein the vehicle electrical system does not monitor sensor data sensed by the sensor;
wherein the electronic processor is configured to:
receive the sensor data from the sensor, and
transmit the sensor data to the electronic communication device via the second connection.

18. The docking station of claim 15, wherein the first connection includes an on-board diagnostics (OBD) II connector configured to connect to an OBD II port of the vehicle, and wherein the second connection includes a universal serial bus (USB) connector configured to connect to a USB port of the electronic communication device.

19. The docking station of claim 15, wherein the electronic processor is configured to:
receive a command from the electronic communication device via the second connection; and
transmit the command to the vehicle electrical system via the first connection to cause the vehicle electrical system to control a component of the vehicle in accordance with the command.

20. The docking station of claim 15, wherein the external device is remotely located from the vehicle;
wherein the electronic processor is configured to transmit the notification, the vehicle data, or both the notification and the vehicle data to the external device via a network connection of the electronic communication device; and
wherein the docking station does not include its own network connection to communicate directly with the external device.
